(19) United States
(12) Patent Application Publication
(10) Pub. No.: US 2025/0234930 A1
(43) Pub. Date: Jul. 24, 2025

(54) AEROSOL GENERATING DEVICE

(71) Applicant: KT&G CORPORATION, Daejeon (KR)

(72) Inventors: Byungsung CHO, Gwangmyung-si Gyeonggi-do (KR); Sangkyu PARK, Seoul (KR); Jongsub LEE, Sungnam-si Gyeonggi-do (KR); Wooseok CHUNG, Namyangju-si Gyeonggi-do (KR); Daenam HAN, Seoul (KR)

(73) Assignee: KT&G CORPORATION, Daejeon (KR)

(21) Appl. No.: 18/699,192

(22) PCT Filed: Oct. 18, 2022
(86) PCT No.: PCT/KR2022/015845

§ 371 Date: Apr. 5, 2024

(30) Foreign Application Priority Data
Oct. 20, 2021 (KR) 10-2021-0140324
Mar. 10, 2022 (KR) 10-2022-0030273

(51) Int. Cl. A24F 40/51; A24F 40/10; A24F 40/42; A24F 40/53; A24F 40/57; A24F 40/60; G01F 23/263

(52) U.S. Cl. CPC A24F 40/51; A24F 40/10; A24F 40/42; A24F 40/53; A24F 40/57; A24F 40/60; G01F 23/268

(57) ABSTRACT

An aerosol generating device is provided. The aerosol generating device includes: an elongated chamber storing a liquid aerosol generating substance; and a level sensor disposed inside the chamber, wherein the level sensor includes: an insulator substrate extending in a longitudinal direction of the chamber; and a plurality of sensing electrodes each made of a conductor extending in the longitudinal direction and disposed to be laterally spaced apart from each other on the insulator substrate, and wherein at least a portion of the plurality of sensing electrodes is positioned to contact the liquid aerosol generating substance in the chamber.

### TECHNICAL FIELD

The present disclosure relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to provide an aerosol generating device that can accurately determine the amount of aerosol generating substance in a cartridge.

It is yet another objective of the present disclosure to provide an aerosol generating device that can adjust power supplied to a heater when an aerosol generating substance is exhausted.

It is yet another objective of the present disclosure to provide an aerosol generating device that can allow a user to be properly informed of exhaustion of an aerosol generating substance and the replacement time of a cartridge.

### Solution to Problem

According to one aspect of the subject matter described in this application, an aerosol generating device includes: an elongated chamber configured to store a liquid aerosol generating substance; and a level sensor disposed inside the chamber, wherein the level sensor includes: an insulator substrate extending in a longitudinal direction of the chamber; and a plurality of sensing electrodes each made of a conductor extending in the longitudinal direction and disposed to be laterally spaced apart from each other on the insulator substrate, and wherein at least a portion of the plurality of sensing electrodes is positioned to contact the liquid aerosol generating substance in the chamber.

### Advantageous Effects of Invention

According to at least one of the embodiments of the present disclosure, the amount of aerosol generating substance in a cartridge may be accurately determined.

According to at least one of the embodiments of the present disclosure, power supplied to a heater may be adjusted or controlled when an aerosol generating substance is exhausted.

According to at least one of the embodiments of the present disclosure, exhaustion of an aerosol generating substance and the replacement time of a cartridge may be properly informed to a user.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### BRIEF DESCRIPTION OF DRAWINGS

FIG. 1 is a block diagram illustrating an example of an aerosol generating device.

FIGS. 2 and 3 are views referenced to describe examples of an aerosol generating device.

FIGS. 4 to 6 are views referenced to describe examples of a stick.

FIG. 7 is a view illustrating an example of a structure of an aerosol generating device.

FIGS. 8 to 11 are views referenced to describes examples of an aerosol generating device.

FIG. 12 is a flowchart illustrating an example of the operation of an aerosol generating device.

FIGS. 13 and 14 are views for explaining the operation of the aerosol generating device.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

FIG. 1 is a block diagram of an aerosol generating device according to an embodiment of the present disclosure.

Referring to FIG. 1, an aerosol generating device 10 may include a communication interface 11, an input/output interface 12, an aerosol generating module 13, a memory 14, a sensor module 15, a battery 16, and/or a controller 17.

In one embodiment, the aerosol generating device 10 may consist of only a body 100. In this case, components included in the aerosol generating device 10 may be disposed in the body 100. In another embodiment, the aerosol generating device 10 may consist of a cartridge 200, which contains an aerosol generating substance, and a body 100. In this case, components included in the aerosol generating device 10 may be disposed in at least one of the body 100 and the cartridge 200.

The communication interface 11 may include at least one communication module for communication with an external device and/or a network. For example, the communication interface 11 may include a communication module for wired communication such as a Universal Serial Bus (USB). For example, the communication interface 11 may include a communication module for wireless communication such as Wireless Fidelity (Wi-Fi), Bluetooth, Bluetooth Low Energy (BLE), ZigBee, or Near-Field Communication (NFC).

The input/output interface 12 may include an input device for receiving a command from a user and/or an output device 122 for outputting information to the user. For example, the input device may include a touch panel, a physical button, a microphone, etc. For example, the output device 122 may include a display device for outputting visual information, such as a display or a light-emitting diode (LED), an audio device for outputting auditory information, such as a speaker or a buzzer, a motor for outputting tactile information, such as a haptic effect, etc.

The input/output interface 12 may transmit data corresponding to a command input by the user through the input device to another component (or other components) of the aerosol generating device 10. The input/output interface 12 may output information corresponding to data received from another component (or other components) of the aerosol generating device 10 through the output device 122.

The aerosol generating module 13 may generate an aerosol from an aerosol generating substance. Here, the aerosol generating substance may be a substance in a liquid state, a solid state, or a gel state, which can produce an aerosol, or a combination of two or more aerosol generating substances.

In one embodiment, the liquid aerosol generating substance may be a liquid including a tobacco-containing material having a volatile tobacco flavor component. In another embodiment, the liquid aerosol generating substance may be a liquid including a non-tobacco material. For example, the liquid aerosol generating substance may include water, solvents, nicotine, plant extracts, flavorings, flavoring agents, vitamin mixtures, etc.

The solid aerosol generating substance may include a solid material based on a tobacco raw material such as a reconstituted tobacco sheet, shredded tobacco, or granulated tobacco. In addition, the solid aerosol generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol generating substance may further include an aerosol forming agent such as glycerin or propylene glycol.

The aerosol generating module 13 may include at least one heater.

The aerosol generating module 13 may include an electro-resistive heater. For example, the electro-resistive heater may include at least one electrically conductive track. The electro-resistive heater may be heated by the current flowing through the electrically conductive track. Here, the aerosol generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may have any one of a tubular shape, a plate shape, a needle shape, a rod shape, and a coil shape.

The aerosol generating module 13 may include a heater that uses an induction-heating method, namely, an induction heater. For example, the induction heater may include an electrically conductive coil. The induction heater may generate an alternating magnetic field, which periodically changes in direction, by adjusting the current flowing through the electrically conductive coil. In this case, when the alternating magnetic field is applied to a magnetic body, energy loss may occur in the magnetic body due to eddy current loss and hysteresis loss, and the lost energy may be released as thermal energy. Accordingly, the aerosol generating substance located adjacent to the magnetic body may be heated. Here, an object that generates heat due to the magnetic field may be referred to as a susceptor.

Meanwhile, the aerosol generating module 13 may generate ultrasonic vibrations to thereby produce an aerosol from the aerosol generating substance.

The aerosol generating module 13 may be referred to as a cartomizer, an atomizer, or a vaporizer.

When the aerosol generating device 10 consists of a cartridge 200 containing an aerosol generating substance, and a body 100, the aerosol generating module 13 may be disposed in at least one of the body 100 and the cartridge 200.

The memory 14 may store therein a program for processing and controlling each signal in the controller 17. The memory 14 may store therein data processed and data to be processed by the controller 17.

For example, the memory 14 may store therein applications designed for the purpose of performing various tasks that can be processed by the controller 17. For example, the memory 14 may selectively provide some of the stored applications in response to a request from the controller 17.

For example, the memory 14 may store therein data regarding an operation time of the aerosol generating device 10, the maximum number of puffs, the current number of puffs, the number of charging times of the battery 16, the number of discharging times of the battery 16, at least one temperature profile, a user's inhalation pattern, and charging/discharging. Here, the “puff(s)” may refer to inhalation by a user, and the “inhalation” may refer to the user's act of taking air or other substances into the user's oral cavity, nasal cavity, or lungs through the user's mouth or nose.

For example, information may be stored in the memory 14 by matching the magnitude of impedance between a plurality of sensing electrodes of a level sensor to the amount of liquid aerosol generating substance in a cartridge.

The memory 14 may include at least one of volatile memory (e.g., dynamic random access memory (DRAM), static random access memory (SRAM), and synchronous dynamic random access memory (SDRAM)), nonvolatile memory (e.g., flash memory), a hard disk drive (HDD), and a solid-state drive (SSD).

The memory 14 may be disposed in at least one of the body 100 and the cartridge 200. The memory 14 may be disposed in each of the body 100 and the cartridge 200. For example, a memory of the body 100 may store information regarding components disposed in the body 100, namely, information regarding the full charge capacity of the battery 16. For example, the memory of the body 100 may store cartridge information received from the cartridge 200 previously or currently coupled to the body 100, and a memory of the cartridge 200 may store cartridge information including cartridge identification information (ID information), a cartridge type, and the like.

The sensor module 15 may include at least one sensor.

For example, the sensor module 15 may include a sensor for sensing a puff (hereinafter referred to as a “puff sensor”). Here, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a temperature of the heater included in the aerosol generating module 13 and a temperature of the aerosol generating substance (hereinafter referred to as a “temperature sensor”).

In this case, the heater included in the aerosol generating module 13 may serve as the temperature sensor. For example. the electro-resistive material of the heater may be a material having a temperature coefficient of resistance (TCR). The sensor module 15 may measure the resistance of the heater, which varies according to temperature, to thereby sense the temperature of the heater.

For example, when a stick is capable of being inserted into the body 100 of the aerosol generating device 10, the sensor module 15 may include a sensor for sensing insertion of the stick (hereinafter referred to as a “stick detection sensor”).

For example, when the aerosol generating device 10 includes a cartridge 200, the sensor module 15 may include a sensor for sensing mounting/removal (or attachment/detachment) of the cartridge 200 to/from the body 100 and a position of the cartridge 200 (hereinafter referred to as a “cartridge detection sensor”).

In this case, the stick detection sensor and/or the cartridge detection sensor may be implemented as an inductance-based sensor, a capacitance sensor, a resistance sensor, or a Hall IC using a Hall effect. In some embodiments, the cartridge detection sensor may include a connection terminal. The connection terminal may be provided in the body 100. As the cartridge 200 is coupled to the body 100, the connection terminal may be electrically connected to electrodes disposed in the cartridge 200.

For example, the sensor module 15 may include a voltage sensor for sensing a voltage applied to a component (e.g., the battery 16) provided in the aerosol generating device 10 and/or a current sensor for sensing a current.

For example, the sensor module 15 may include at least one sensor for sensing the movement of the aerosol generating device 10 (hereinafter referred to as a “motion sensor” 154). Here, the motion sensor 154 may be implemented as at least one of a gyro sensor and an acceleration sensor. The motion sensor 154 may be disposed in at least one of the body 100 and the cartridge 200.

For example, the sensor module 15 may include a sensor for sensing the amount of liquid aerosol generating substance present in a chamber C1 of the aerosol generating device 10 (hereinafter referred to as a “level sensor” 250). In this case, the level sensor 250 may include a plurality of sensing electrodes spaced apart from each other on an insulator substrate. The plurality of sensing electrodes may be in contact with a liquid aerosol generating substance in the chamber C1. The magnitude of impedance between the plurality of sensing electrodes of the level sensor 250 may vary depending on the amount of liquid aerosol generating substance present in the chamber C1.

The battery 16 may supply power used for the operation of the aerosol generating device 10 under the control of the controller 17. The battery 16 may supply power to other components provided in the aerosol generating device 10. For example, the battery 16 may supply power to the communication module included in the communication interface 11, the output device included in the input/output interface 12, and the heater included in the aerosol generating module 13.

The battery 16 may be a rechargeable battery or a disposable battery. For example, the battery 16 may be a lithium-ion battery or a lithium polymer (Li-polymer) battery, but is not limited thereto. For example, when the battery 16 is rechargeable, a charge rate (C-rate) of the battery 16 may be 10 C, and a discharge rate (C-rate) thereof may be 10 C to 20 C. However, the present disclosure is not limited thereto. In addition, for stable use, the battery 16 may be designed to retain 80% or more of its original capacity at 2,000 full charge and discharge cycles.

The aerosol generating device 10 may further include a battery protection circuit module (PCM), which is a circuit for protecting the battery 16. The battery protection circuit module (PCM) may be disposed adjacent to an upper surface of the battery 16. For example, in order to prevent overcharging and overdischarging of the battery 16, the battery protection circuit module (PCM) may cut off an electrical path to the battery 16 when a short circuit occurs in a circuit connected to the battery 16, when an overvoltage is applied to the battery 16, or when an excessive current flows through the battery 16.

The aerosol generating device 10 may further include a charging terminal to which power supplied from the outside is input. For example, the charging terminal may be provided at one side of the body 100 of the aerosol generating device 10. The aerosol generating device 10 may charge the battery 16 using the power supplied through the charging terminal. In this case, the charging terminal may be configured as a wired terminal for USB communication, a pogo pin, or the like.

The aerosol generating device 10 may wirelessly receive power supplied from the outside through the communication interface 11. For example, the aerosol generating device 10 may wirelessly receive power using an antenna included in the communication module for wireless communication. For example, the aerosol generating device 10 may charge the battery 16 using the wirelessly supplied power.

The controller 17 may control the overall operation of the aerosol generating device 10. The controller 17 may be connected to each of the components provided in the aerosol generating device 10. The controller 17 may transmit and/or receive a signal to and/or from each of the components, thereby controlling the overall operation of each of the components.

The controller 17 may include at least one processor. The controller 17 may control the overall operation of the aerosol generating device 10 through the processor included therein. Here, the processor may be a general processor such as a central processing unit (CPU). Alternatively, the processor may be a dedicated device such as an application-specific integrated circuit (ASIC) or any of other hardware-based processors.

The controller 17 may control such that a voltage is applied to the plurality of sensing electrodes of the level sensor 250, and may measure impedance between the plurality of sensing electrodes. In this case, an AC voltage may be applied between the plurality of sensing electrodes. The controller 17 may calculate the amount of liquid aerosol generating substance in the chamber C1 based on the magnitude of the measured impedance.

The controller 17 may perform any one of a plurality of functions of the aerosol generating device 10. For example, the controller 17 may perform any one of a plurality of functions of the aerosol generating device 10 (e.g., a preheating function, a heating function, a charging function, and a cleaning function) according to the state of each of the components provided in the aerosol generating device 10, a user command received through the input/output interface 12, and the like.

The controller 17 may control the operation of each of the components provided in the aerosol generating device 10 based on data stored in the memory 14. For example, the controller 17 may control such that predetermined power is supplied from the battery 16 to the aerosol generating module 13 for a predetermined time based on data stored in the memory 14 such as the temperature profile and the user's inhalation pattern.

The controller 17 may determine the occurrence or non-occurrence of a puff through the puff sensor included in the sensor module 15. For example, the controller 17 may check a temperature change, a flow change, a pressure change, and a voltage change in the aerosol generating device 10 based on values sensed by the puff sensor. For example, the controller 17 may determine the occurrence or non-occurrence of a puff according to the result of checking based on a value sensed by the puff sensor.

The controller 17 may control the operation of each of the components provided in the aerosol generating device 10 according to the occurrence or non-occurrence of a puff and/or the number of puffs. For example, the controller 17 may control the temperature of the heater to be changed or maintained based on the temperature profile stored in the memory 14.

The controller 17 may control such that the supply of power to the heater is interrupted according to a predetermined condition. For example, the controller 17 may control such that the supply of power to the heater is cut off when a stick is removed, when the cartridge 200 is removed from the body 100, when the number of puffs reaches the predetermined maximum number of puffs, when a puff is not sensed for a predetermined time or longer, or when the remaining capacity of the battery 16 is less than a predetermined value.

The controller 17 may calculate the remaining capacity (hereinafter referred to as the “remaining amount of power”) with respect to the full charge capacity of the battery 16. For example, the controller 17 may calculate the remaining amount of power of the battery 16 based on a value sensed by the voltage sensor and/or the current sensor included in the sensor module 15.

The controller 17 may control such that power is supplied to the heater using at least one of a pulse width modulation (PWM) method and a proportional-integral-differential (PID) method.

For example, the controller 17 may control such that a current pulse having a predetermined frequency and a predetermined duty ratio is supplied to the heater using the PWM method. In this case, the controller 17 may control power supplied to the heater by adjusting the frequency and the duty ratio of the current pulse.

For example, the controller 17 may determine a target temperature to be controlled based on the temperature profile. In this case, the controller 17 may control power supplied to the heater using the PID method, which is a feedback control method using a difference value between the temperature of the heater and the target temperature, a value obtained by integrating the difference value with respect to time, and a value obtained by differentiating the difference value with respect to time.

For example, the controller 17 may control power supplied to the heater based on the temperature profile. The controller 17 may control a length of a heating section for heating the heater, the amount of power supplied to the heater in the heating section, and the like. The controller 17 may control power supplied to the heater based on the target temperature of the heater.

Although the PWM method and the PID method are described as exemplary methods of controlling the supply of power to the heater, the present disclosure is not limited thereto. Other various control methods, such as a proportional-integral (PI) method and a proportional-differential (PD) method, may also be used.

The controller 17 may determine a temperature of the heater, and may adjust the amount of power supplied to the heater according to the temperature of the heater. For example, the controller 17 may determine the temperature of the heater by checking a resistance value of the heater, a current flowing through the heater, and/or a voltage applied to the heater.

Meanwhile, the controller 17 may control such that power is supplied to the heater according to a predetermined condition. For example, when a cleaning function for cleaning a space into which a stick is inserted is selected according to a command input by the user through the input/output interface 12, the controller 17 may control such that predetermined power is supplied to the heater.

FIGS. 2 to 3 are views for explaining an aerosol generating device according to embodiments of the present disclosure.

Referring to FIG. 2, the aerosol generating device 10 according to this embodiment may include a body 100 that supports a cartridge 200 and the cartridge 200 that contains an aerosol generating substance.

In one embodiment, the cartridge 200 may be configured to be detachably attached to the body 100. In another embodiment, the cartridge 200 may be integrally formed with the body 100. For example, at least a portion of the cartridge 200 may be inserted into an inner space defined by a housing 101 of the body 100, allowing the cartridge 200 to be mounted to the body 100.

The body 100 may have a structure that allows outside or external air to be introduced therein with the cartridge 200 inserted. Here, the external air introduced into the body 100 may pass through the cartridge 200 to flow into the mouth of a user.

The controller 17 may determine mounting/removal of the cartridge 200 through the cartridge detection sensor included in the sensor module 15. For example, the cartridge detection sensor may transmit a pulse current through one terminal connected to the cartridge 200. In this case, the cartridge detection sensor may detect connection or disconnection of the cartridge 200 based on whether the pulse current is received through another terminal.

The cartridge 200 may include a heater 210 that heats an aerosol generating substance and/or a storage portion 220 that stores the aerosol generating substance. For example, a liquid delivery element impregnated with (containing) the aerosol generating substance may be disposed in the storage portion 220. An electrically conductive track of the heater 210 may have a structure wound around the liquid delivery element. As the liquid delivery element is heated by the heater 210, an aerosol may be produced. Here, the liquid delivery element may be a wick such as cotton fiber, ceramic fiber, glass fiber, or porous ceramic.

The cartridge 200 may include an insertion space 230 configured to allow a stick 20 to be inserted therein. For example, the cartridge 200 may include an insertion space defined by an inner wall (not shown) extending in a circumferential direction along a direction in which the stick 20 is inserted. Here, an inside of the inner wall may be open vertically to define the insertion space. The stick 20 may be inserted into the insertion space 230 defined by the inner wall.

The insertion space into which the stick 20 is inserted may have a shape corresponding to a shape of a portion of the stick 20 inserted into the insertion space. For example, when the stick 20 has a cylindrical shape, the insertion space may be formed in a cylindrical shape.

When the stick 20 is inserted into the insertion space, an outer circumferential surface of the stick 20 may be surrounded by the inner wall to be in contact with the inner wall.

The stick 20 may be similar to a general combustive cigarette. For example, the stick 20 may be divided into a first part including an aerosol generating substance and a second part including a filter and the like. Alternatively, the second part of the stick 20 may also include an aerosol generating substance. For example, an aerosol generating substance made in the form of granules or capsules may be inserted into the second part.

The entire first part may be inserted into the insertion space 230, and the second part may be exposed to the outside. Alternatively, only a portion of the first part may be inserted into the insertion space 230, or portions of the first part and the second part may be inserted into the insertion space 230. The user may inhale an aerosol while holding the second part in his or her mouth. As external air passes through the first part, an aerosol may be generated, and the generated aerosol may pass through the second part to be delivered to the mouth of the user.

The user may inhale an aerosol while holding one end of the stick 20 in his or her mouth. An aerosol generated by the heater 210 may pass through the stick 20 to be delivered to the mouth of the user. Here, a material included in the stick 20 may be added to the aerosol while passing through the stick 20, and the material-added aerosol may be inhaled into the mouth of the user through the one end of the stick 20.

The controller 17 may monitor the number of puffs upon insertion of the stick 20 based on a value sensed by the puff sensor.

When the inserted stick 20 is removed, the controller 17 may initialize the current number of puffs stored in the memory 14.

Referring to FIG. 3, the aerosol generating device 10 according to this embodiment may include a body 100 that supports a cartridge 200 and the cartridge 200 that contains an aerosol generating substance. The body 100 may be configured such that a stick 20 is insertable into an insertion space 130.

The aerosol generating device 10 may include a first heater configured to heat the aerosol generating substance stored in the cartridge 200. For example, when a user puffs on one end of the stick 20 with his or her mouth, an aerosol generated by the first heater may pass through the stick 20. Here, a flavoring may be added to the aerosol while passing through the stick 20. The flavored aerosol may be inhaled into the mouth of the user through the one end of the stick 20.

In another embodiment, the aerosol generating device 10 may include a first heater configured to heat the aerosol generating substance stored in the cartridge 200 and a second heater configured to heat the stick 20 inserted into the body 100. For example, the aerosol generating device 10 may generate an aerosol by heating the aerosol generating substance stored in the cartridge 200 and the stick 20 through the first heater and the second heater, respectively.

FIGS. 4 to 6 are views for explaining a stick according to embodiments of the present disclosure. Overlapping descriptions in FIGS. 4 to 6 will be omitted.

Referring to FIG. 4, a stick 20 according to this embodiment may include a tobacco rod 21 and a filter rod 22. The first part described above with reference to FIG. 2 may include the tobacco rod 21. The second part described above with reference to FIG. 2 may include the filter rod 22.

The filter rod 22 in FIG. 4 is shown as a single segment but is not limited thereto. In other words, the filter rod 22 may include a plurality of segments. For example, the filter rod 22 may include a first segment for cooling an aerosol and a second segment for filtering a predetermined component included in the aerosol. In addition, when necessary, the filter rod 22 may further include at least one segment performing another function.

A diameter of the stick 20 may be in a range of 5 mm to 9 mm, and a length of the stick 20 may be about 48 mm. However, the present disclosure is not limited thereto. For example, a length of the tobacco rod 21 may be about 12 mm, a length of the first segment of the filter rod 22 may be about 10 mm, a length of the second segment of the filter rod 22 may be about 14 mm, and a length of a third segment of the filter rod 22 may be about 12 mm. However, the present disclosure is not limited thereto.

The stick 20 may be wrapped by at least one wrapper 24. The wrapper 24 may have at least one hole through which external air is introduced or internal gas is discharged. In one example, the stick 20 may be wrapped by one wrapper 24. In another example, the stick 20 may be wrapped by two or more wrappers 24 in an overlapping manner. For example, the tobacco rod 21 may be wrapped by a first wrapper 241. For example, the filter rod 22 may be wrapped by second wrappers 242, 243, and 244. The tobacco rod 21 and the filter rod 22, which are wrapped by the respective wrappers, may be coupled to each other. The entire stick 20 may be rewrapped by a third wrapper 245. When the filter rod 22 consists of a plurality of segments, each of the segments may be wrapped by an individual wrapper (242, 243, 244). In addition, the entire stick 20 in which the segments respectively wrapped by the individual wrappers are coupled to one another may be rewrapped by another wrapper.

The first wrapper 241 and the second wrapper 242 may be made of general filter wrapping paper. For example, the first wrapper 241 and the second wrapper 242 may be porous wrappers or non-porous wrappers. In addition, the first wrapper 241 and the second wrapper 242 may be made of paper and/or an aluminum laminate packaging material with oil resistance.

The third wrapper 243 may be made of hard wrapping paper. For example, a basis weight of the third wrapper 243 may be in a range of 88 g/m² to 96 g/m². For example, a basis weight of the third wrapper 243 may be in a range of 90 g/m² to 94 g/m². In addition, a thickness of the third wrapper 243 may be in a range of 120 μm to 130 μm. For example, the thickness of the third wrapper 243 may be 125 μm.

The fourth wrapper 244 may be made of an oil-resistant hard wrapping paper. For example, a basis weight of the fourth wrapper 244 may be in a range of 88 g/m² to 96 g/m². For example, a basis weight of the fourth wrapper 244 may be in a range of 90 g/m² to 94 g/m². In addition, a thickness of the fourth wrapper 244 may be in a range of 120 μm to 130 μm. For example, the thickness of the fourth wrapper 244 may be 125 μm.

The fifth wrapper 245 may be made of sterile paper (MFW). Here, the sterile paper (MFW) may refer to paper specially designed to have improved tensile strength, water resistance, smoothness, and the like compared to general paper. For example, a basis weight of the fifth wrapper 245 may be in a range of 57 g/m² to 63 g/m². For example, a basis weight of the fifth wrapper 245 may be 60 g/m². In addition, a thickness of the fifth wrapper 245 may be in a range of 64 μm to 70 μm. For example, the thickness of the fifth wrapper 245 may be 67 μm.

A predetermined material may be added into the fifth wrapper 245. Here, an example of the predetermined material may be silicone, but is not limited thereto. For example, silicone may have properties such as heat resistance having little change with temperature, oxidation resistance, resistance to various chemicals, water repellency to water, electrical insulation, etc. However, other than the silicone, any material having the above-described properties may be applied onto or coated on the fifth wrapper 245.

The fifth wrapper 245 may prevent combustion of the stick 20. For example, when the tobacco rod 21 is heated by the heater 110, there may exist a possibility of combustion of the stick 20. In detail, when the temperature rises above the ignition point of any one of the materials included in the tobacco rod 21, the stick 20 may be combustible. However, as the fifth wrapper 245 includes a non-combustible material, the combustion of the stick 20 may be prevented.

In addition, the fifth wrapper 245 may prevent the body 100 from being contaminated by materials generated in the stick 20. Liquid materials may be generated in the stick 20 due to a puff by a user. For example, as an aerosol produced in the stick 20 is cooled by external air, liquids (e.g., moisture, etc.) may be generated. As the stick 20 is wrapped by the fifth wrapper 245, the liquids generated in the stick 20 may be prevented from leaking out of the stick 20.

The tobacco rod 21 may include an aerosol generating substance. For example, the aerosol generating substance may include, but is not limited to, at least one of glycerin, propylene glycol, ethylene glycol, dipropylene glycol, diethylene glycol, triethylene glycol, tetraethylene glycol, and oleyl alcohol. Also, the tobacco rod 21 may contain other additives such as a flavoring agent, a wetting agent, and/or an organic acid. In addition, a flavoring liquid, such as menthol or humectant, may be added to the tobacco rod 21 by being sprayed onto the tobacco rod 21.

The tobacco rod 21 may be manufactured in various ways. For example, the tobacco rod 21 may be formed as a sheet. For example, the tobacco rod 21 may be formed as strands. For example, the tobacco rod 21 may be formed as shredded tobacco obtained by finely cutting a tobacco sheet. For example, the tobacco rod 21 may be surrounded by a heat conductive material. For example, the heat conductive material may be a metal foil such as aluminum foil, but is not limited thereto. For example, the heat conductive material surrounding the tobacco rod 21 may evenly distribute heat transferred to the tobacco rod 21 to thereby increase conductivity of the heat applied to the tobacco rod 21. As a result, the taste of tobacco may be improved. The heat conductive material surrounding the tobacco rod 21 may serve as a susceptor heated by an induction heater. Although not shown in the drawing, the tobacco rod 21 may further include an additional susceptor, in addition to the heat conductive material surrounding an outside thereof.

The filter rod 22 may be a cellulose acetate filter. Moreover, the filter rod 22 is not limited to a particular shape. For example, the filter rod 22 may be a cylinder type rod. For example, the filter rod 22 may be a tube type rod including a hollow therein. For example, the filter rod 22 may be a recess type rod. When the filter rod 22 consists of a plurality of segments, at least one of the plurality of segments may have a different shape from the others.

The first segment of the filter rod 22 may be a cellulose acetate filter. For example, the first segment may be a tube-shaped structure including a hollow therein. The first segment may prevent an inner material of the tobacco rod 21 from being pushed back upon insertion of the heater 110, and may provide the effect of cooling an aerosol. A diameter of the hollow included in the first segment may be appropriately determined or selected in a range of 2 mm to 4.5 mm, but is not limited thereto.

A length of the first segment may be appropriately determined in a range of 4 mm to 30 mm, but is not limited thereto. For example, the length of the first segment may be 10 mm, but is not limited thereto.

The second segment of the filter rod 22 cools an aerosol generated when the heater 110 heats the tobacco rod 21. Thus, the user may inhale an aerosol cooled to an appropriate temperature.

A length or diameter of the second segment may be variously determined according to the shape of the stick 20. For example, the length of the second segment may be appropriately selected in a range of 7 mm to 20 mm. More preferably, the length of the second segment may be about 14 mm, but is not limited thereto.

The second segment may be made by weaving polymer fibers. In this case, a flavoring liquid may be applied to a fiber made of polymers. Alternatively, the second segment may be made by weaving a separate fiber coated with a flavoring liquid and a fiber made of polymers together. Alternatively, the second segment may be made of a crimped polymer sheet.

For example, a polymer may be made of a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is made of the woven polymer fiber or the crimped polymer sheet, the second segment may include a single channel or a plurality of channels extending in a longitudinal direction. Here, the “channel” may refer to a passage through which gas (e.g., air or aerosol) passes.

For example, the second segment made of a crimped polymer sheet may be made from a material having a thickness between 5 μm and 300 μm, namely, between 10 μm and 250 μm. Also, a total surface area of *?* the second segment may be between 300 mm²/mm and 1000 mm²/mm. In addition, an aerosol cooling element may be made from a material with a specific surface area between 10 mm²/mg and 100 mm²/mg.

Meanwhile, the second segment may include a thread containing a volatile flavor component. Here, the volatile flavor component may be menthol, but is not limited thereto. For example, the thread may be filled with a sufficient amount of menthol to provide at least 1.5 mg of menthol to the second segment.

The third segment of the filter rod 22 may be a cellulose acetate filter. A length of the third segment may be appropriately selected in a range of 4 mm to 20 mm. For example, the length of the third segment may be about 12 mm, but is not limited thereto.

The filter rod 22 may be manufactured to generate flavor. In one example, a flavoring liquid may be sprayed onto the filter rod 22. In another example, a separate fiber coated with a flavoring liquid may be inserted into the filter rod 22.

In addition, the filter rod 22 may include at least one capsule 23. Here, the capsule 23 may perform a function of generating flavor. The capsule 23 may also perform a function of generating an aerosol. For example, the capsule 23 may have a structure in which a liquid containing a flavoring material is wrapped with a film. The capsule 23 may have a spherical or cylindrical shape, but is not limited thereto.

Referring to FIG. 5, a stick 30 according to this embodiment may further include a front-end plug 33. The front-end plug 33 is disposed on one side opposite a filter rod 32 with respect to a tobacco rod 31. The front-end plug 33 may prevent the tobacco rod 31 from being separated to the outside. The front-end plug 33 may prevent a liquefied aerosol from flowing into the aerosol generating device 10 from the tobacco rod 31 while smoking.

The filter rod 32 may include a first segment 321 and a second segment 322. The first segment 321 may correspond to the first segment of the filter rod 22 of FIG. 4. The second segment 322 may correspond to the third segment of the filter rod 22 of FIG. 4.

A diameter and an overall length of the stick 30 may correspond to the diameter and the overall length of the stick 20 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm. However, the present disclosure is not limited thereto.

The stick 30 may be wrapped by at least one wrapper 35. The wrapper 35 may have at least one hole through which external air is introduced or internal gas is discharged. For example, the front-end plug 33 may be wrapped by a first wrapper 351, the tobacco rod 31 may be wrapped by a second wrapper 352, the first segment 321 may be wrapped by a third wrapper 353, and the second segment 322 may be wrapped by a fourth wrapper 354. Then, the entire stick 30 may be rewrapped by a fifth wrapper 355.

In addition, the fifth wrapper 355 may have at least one perforation 36. For example, the perforation 36 may be formed in an area surrounding the tobacco rod 31, but is not limited thereto. For example, the perforation 36 may serve to transfer heat generated by the heater 210 of FIG. 2 to an inside of the tobacco rod 31.

Also, the second segment 322 may include at least one capsule 34. Here, the capsule 34 may perform a function of generating flavor. The capsule 34 may also perform a function of generating an aerosol. For example, the capsule 34 may have a structure in which a liquid containing a flavoring material is wrapped with a film. The capsule 34 may have a spherical or cylindrical shape, but is not limited thereto.

The first wrapper 351 may be made by coupling a metal foil, such as aluminum foil, to general filter wrapping paper. For example, a total thickness of the first wrapper 351 may be in a range of 45 μm to 55 μm. For example, the total thickness of the first wrapper 351 may be 50.3 μm. In addition, a thickness of the metal foil of the first wrapper 351 may be in a range of 6 μm to 7 μm. For example, the thickness of the metal foil of the first wrapper 351 may be 6.3 μm. In addition, a basis weight of the first wrapper 351 may be in a range of 50 g/m² to 55 g/m². For example, the basis weight of the first wrapper 351 may be 53 g/m².

The second wrapper 352 and the third wrapper 353 may be made of general filter wrapping paper. For example, the second wrapper 352 and the third wrapper 353 may be porous wrappers or non-porous wrappers.

For example, porosity of the second wrapper 352 may be 35000 CU, but is not limited thereto. In addition, a thickness of the second wrapper 352 may be in a range of 70 μm to 80 μm. For example, the thickness of the second wrapper 352 may be 78 μm. In addition, a basis weight of the second wrapper 352 may be in a range of 20 g/m² to 25 g/m². For example, the basis weight of the second wrapper 352 may be 23.5 g/m².

For example, porosity of the third wrapper 353 may be 24000 CU, but is not limited thereto. In addition, a thickness of the third wrapper 353 may be in a range of 60 μm to 70 μm. For example, the thickness of the third wrapper 353 may be 68 μm. In addition, a basis weight of the third wrapper 353 may be in a range of 20 g/m² to 25 g/m². For example, the basis weight of the third wrapper 353 may be 21 g/m².

The fourth wrapper 354 may be made of PLA laminated paper. Here, the PLA laminated paper may refer to a three-layer paper consisting of a paper layer, a PLA layer, and a paper layer. For example, a thickness of the fourth wrapper 354 may be in a range of 100 μm to 120 μm. For example, the thickness of the fourth wrapper 354 may be 110 μm. In addition, a basis weight of the fourth wrapper 354 may be in a range of 80 g/m² to 100 g/m². For example, the basis weight of the fourth wrapper 354 may be 88 g/m².

The fifth wrapper 355 may be made of sterile paper (MFW). Here, the sterile paper (MFW) may refer to paper specially designed to have improved tensile strength, water resistance, smoothness, and the like compared to general paper. For example, a basis weight of the fifth wrapper 355 may be in a range of 57 g/m² to 63 g/m². For example, the basis weight of the fifth wrapper 355 may be 60 g/m². In addition, a thickness of the fifth wrapper 355 may be in a range of 64 μm to 70 μm. For example, the thickness of the fifth wrapper 355 may be 67 μm.

A predetermined material may be added into the fifth wrapper 355. Here, an example of the predetermined material may be silicone, but is not limited thereto. For example, silicone has properties such as heat resistance with little change with temperature, oxidation resistance, resistance to various chemicals, water repellency to water, electrical insulation, etc. However, other than the silicone, any material having the above-described properties may be applied (or coated) onto the fifth wrapper 355.

The front-end plug 33 may be made of cellulose acetate. In one example, the front-end plug 33 may be made by adding a plasticizer (e.g., triacetin) to cellulose acetate tow. A mono denier of a filament constituting the cellulose acetate tow may be in a range of 1.0 to 10.0. For example, the mono denier of the filament constituting the cellulose acetate tow may be in a range of 4.0 to 6.0. For example, a mono denier of a filament of the front-end plug 33 may be 5.0. In addition, a cross section of the filament of the front-end plug 33 may be a Y-shape. A total denier of the front-end plug 33 may be in a range of 20000 to 30000. For example, the total denier of the front-end plug 33 may be in a range of 25000 to 30000. For example, the total denier of the front-end plug 33 may be 28000.

In addition, when necessary, the front-end plug 33 may include at least one channel. A shape of a cross section of the channel of the front-end plug 330 may be formed in various ways.

The tobacco rod 31 may correspond to the tobacco rod 21 described above with reference to FIG. 4. Therefore, a detailed description of the tobacco rod 31 will be omitted.

The first segment 321 may be made of cellulose acetate. For example, the first segment may be a tube-shaped structure including a hollow therein. The first segment 321 may be made by adding a plasticizer (e.g., triacetin) to cellulose acetate tow. For example, a mono denier and a total denier of the first segment 321 may be the same as the mono denier and the total denier of the front-end plug 33.

The second segment 322 may be made of cellulose acetate. A mono denier of a filament of the second segment 322 may be in a range of 1.0 to 10.0. For example, the mono denier of the filament of the second segment 322 may be in a range of 8.0 to 10.0. For example, the mono denier of the filament of the second segment 322 may be 9.0. In addition, a cross section of the filament of the second segment 322 may be a Y-shape. A total denier of the second segment 322 may be in a range of 20000 to 30000. For example, the total denier of the second segment 322 may be 25000.

Referring to FIG. 6, a stick 40 may include a medium portion 410. The stick 40 may include a cooling portion 420. The stick 40 may include a filter portion 430. The cooling portion 420 may be disposed between the medium portion 410 and the filter portion 430. The stick 40 may include a wrapper 440. The wrapper 440 may wrap the medium portion 410. The wrapper 440 may wrap the cooling portion 420. The wrapper 440 may wrap the filter portion 430. The stick 40 may have a cylindrical shape.

The medium portion 410 may include a medium 411. The medium portion 410 may include a first medium cover 413. The medium portion 410 may include a second medium cover 415. The medium 411 may be disposed between the first medium cover 413 and the second medium cover 415. The first medium cover 413 may be disposed at one end of the stick 40. The medium portion 410 may have a length of 24 mm.

The medium 411 may contain a multicomponent substance. The substance contained in the medium may be a multicomponent flavoring substance. The medium 411 may be composed of a plurality of granules. Each of the plurality of granules may have a size of 0.4 mm to 1.12 mm. The granules may account for approximately 70% of the volume of the medium 411. A length L2 of the medium 411 may be 10 mm. The first medium cover 413 may be made of an acetate material. The second medium cover 415 may be made of an acetate material. The first medium cover 413 may be made of a paper material. The second medium cover 415 may be made of a paper material. At least one of the first medium cover 413 and the second medium cover 415 may be made of a paper material to be crumpled with wrinkles, and a plurality of gaps may be formed between the wrinkles to allow air to flow therethrough. Each of the gaps may be smaller than each of the granules of the medium 411. A length L1 of the first medium cover 413 may be less than the length L2 of the medium 411. A length L3 of the second medium cover 415 may be less than the length L2 of the medium 411. The length L1 of the first medium cover 413 may be 7 mm. The length L2 of the second medium cover 415 may be 7 mm.

Accordingly, each of the granules of the medium 411 may be prevented from being separated from the medium portion 410 and the stick 40.

The cooling portion 420 may have a cylindrical shape. The cooling portion 420 may have a hollow shape. The cooling portion 420 may be disposed between the medium portion 410 and the filter portion 430. The cooling portion 420 may be disposed between the second medium cover 415 and the filter portion 430. The cooling portion 420 may be formed in the shape of a tube that surrounds a cooling path 424 formed therein. The cooling portion 420 may be thicker than the wrapper 440. The cooling portion 420 may be made of a paper material thicker than that of the wrapper 440. A length L4 of the cooling portion 420 may be equal or similar to the length L2 of the medium 411. The length L4, which is the length of the cooling portion 420 and the cooling path 424, may be 10 mm. When the stick 40 is inserted into the aerosol generating device 10, at least a portion of the cooling portion 420 may be exposed to an outside of the aerosol generating device 10.

Accordingly, the cooling portion 420 may support the medium portion 410 and the filter portion 430, and may achieve the rigidity of the stick 40. In addition, the cooling portion 420 may support the wrapper 440 between the medium portion 410 and the filter portion 430, and may provide a portion to which the wrapper 440 is adhered. In addition, heated air and aerosol may be cooled while passing through the cooling path 424 in the cooling portion 420.

The filter portion 430 may be configured as a filter made of an acetate material. The filter portion 430 may be disposed at another end of the stick 40. When the stick 40 is inserted into the aerosol generating device 10, the filter portion 430 may be exposed to the outside of the aerosol generating device 10. A user may inhale air while holding the filter portion 430 in his or her mouth. A length L5 of the filter portion 430 may be 14 mm.

The wrapper 440 may wrap or surround the medium portion 410, the cooling portion 420, and the filter portion 430. The wrapper 440 may define an outer appearance of the stick 40. The wrapper 440 may be made of a paper material. An adhesive portion 441 may be formed along one edge of the wrapper 440. The wrapper 440 may surround the medium portion 410, the cooling portion 420 and the filter portion 430, and the adhesive portion 441 formed along the one edge of the wrapper 440 and another edge of the wrapper 440 may be adhered to each other. The wrapper 440 may surround the medium portion 410, the cooling portion 420, and the filter portion 430, but may not cover one end and another end of the stick 40.

Accordingly, the wrapper 440 may fix the medium portion 410, the cooling portion 420, and the filter portion 430, and may prevent these components from being separated from the stick 40.

A first thin film 443 may be disposed at a position corresponding to the first medium cover 413. The first thin film 443 may be disposed between the wrapper 440 and the first medium cover 413, or may be disposed outside the wrapper 440. The first thin film 443 may surround the first medium cover 413. The first thin film 443 may be made of a metal material. The first thin film 443 may be made of an aluminum material. The first thin film 443 may be in close contact with or coated on the wrapper 440.

A second thin film 445 may be disposed at a position corresponding to the second medium cover 415. The second thin film 445 may be disposed between the wrapper 440 and the second medium cover 415, or may be disposed outside the wrapper 440. The second thin film 445 may be made of a metal material. The second thin film 445 may be made of an aluminum material. The second thin film 445 may be in close contact with or coated on the wrapper 440.

FIG. 7 is a view illustrating a structure of an aerosol generating device, according to an embodiment of the present disclosure, and FIGS. 8 to 11 are views for explaining the aerosol generating device.

Herein, the terms “upstream” and “downstream” may be determined based on a direction of air and/or aerosol flowing into the mouth or lungs of a user when the user puffs on a stick to inhale an aerosol. For example, in FIGS. 4 and 5, since an aerosol generated in the tobacco rod 21, 31 is directed to the filter rod 22, 32, it may be described that the tobacco rod 21, 31 is located at the upper stream side relative to the filter rod 22, 32, and the filter rod 22, 32 is located at the downstream side relative to the tobacco rod 21, 31. The “upstream” and “downstream” may be determined according to the relative position between components.

Herein, the directions of the aerosol generating device 10 may be defined based on the orthogonal coordinate system shown in the drawings. In the orthogonal coordinate system, the x-axis direction may be defined as the left-and-right direction of the aerosol generating device 10. Here, based on the origin, the +x-axis direction may be the right direction, and the −x-axis direction may be the left direction. The y-axis direction may be defined as the up-and-down direction of the aerosol generating device 10. Here, based on the origin, the +y-axis direction may be the up direction, and the −y-axis direction may be the down direction. The z-axis direction may be defined as the front-and-rear direction of the aerosol generating device 10. Here, based on the origin, the +z-axis direction may be the front direction, and the −z-axis direction may be the rear direction.

Referring to FIG. 7, the aerosol generating device 10 may include a body 100 and a cartridge 200. The aerosol generating device 10 may include a heater 210, a motion sensor 154, a level sensor 250, a connection terminal 155, a battery 16, and/or a controller 17.

The cartridge 200 may be detachably attached to the body 100. The cartridge 200 may be provided therein with a chamber C1.

The cartridge 200 may include an outer wall and an inner wall. The chamber C1 may be defined by a space between the outer wall and the inner wall. The chamber C1 may store a liquid aerosol generating substance therein. The liquid aerosol generating substance in the chamber C1 may be heated by the heater 210.

The cartridge 200 may include a wick (not shown). The wick may be connected to the chamber C1. The wick may be supplied with a liquid aerosol generating substance stored in the chamber C1. The liquid aerosol generating substance stored in the chamber C1 may be impregnated in the wick. When the wick is heated by the heater 210, an aerosol may be generated.

The heater 210 may be electrically connected to the battery 16 and/or the controller 17. The heater 210 may be disposed adjacent to the chamber C1, and may heat the wick impregnated with a liquid aerosol generating substance in the chamber C1. The heater 210 may heat the liquid aerosol generating substance in the wick.

The cartridge 200 may be disposed to be in contact with the body 100. The cartridge 200 may be coupled to the body 100 or separated from the body 100. A lower wall of the outer wall of the cartridge 200 may be in contact with the body 100. The connection terminal 155 may be provided on a surface of the body 100 in contact with the cartridge 200. The connection terminal 155 may be disposed to protrude to an outside of the body 100. In a state where the cartridge 200 is coupled to the body 100, the connection terminal 155 may be in contact with a plurality of terminals of the level sensor 250 to achieve an electrical connection.

The level sensor 250 may be disposed inside the chamber C1. At least a portion of a plurality of sensing electrodes of the level sensor 250 may be disposed inside the chamber C1. At least a portion of the plurality of sensing electrodes may be in contact with a liquid aerosol generating substance in the chamber C1.

Referring to FIG. 8, the level sensor 250 may include an insulator substrate 251, a plurality of sensing electrodes 252 and 253, a plurality of terminals 254 and 255, and connection patterns 256 and 257.

The insulator substrate 251 may extend in a longitudinal direction of the chamber C1. The insulator substrate 251 may be in the form of a plate having an elongated shape. The insulator substrate 251 may be made of an insulator.

The plurality of sensing electrodes 252 and 253 may be made of a conductor extending in the longitudinal direction of the chamber C1. The plurality of sensing electrodes 252 and 253 may be disposed to be spaced apart from one another on the insulator substrate 251 in a direction intersecting the longitudinal direction of the chamber C1. For example, the plurality of sensing electrodes 252 and 253 may be disposed on the insulator substrate 251 to be spaced apart from each other at equal intervals in a direction perpendicular to the longitudinal direction of the chamber C1 (the left-and-right direction).

The plurality of sensing electrodes 252 and 253 may include a first electrode 252 and a second electrode 253. The first electrode 252 may include at least one electrode extending in the longitudinal direction of the chamber C1. The second electrode 253 may include at least one electrode extending in the longitudinal direction of the chamber C1 and disposed to be spaced apart from the at least one first electrode 252. Although a structure in which two first electrodes 252 and two second electrodes 253 are provided is illustrated in FIG. 8, the number of the first electrodes 252 and the second electrodes 253 is not limited thereto.

The first electrode 252 and the second electrode 253 may be alternately arranged in a direction intersecting the longitudinal direction of the chamber C1. For example, electrodes may be alternately disposed on the insulator substrate 251 in the order of the first electrode 252, the second electrode 253, the first electrode 252, and the second electrode 253.

As at least one first electrode 252 and at least one second electrode 253 are alternately arranged, at least one second electrode 253 may be disposed adjacent to the first electrode 252, and at least one first electrode 252 may be disposed adjacent to the second electrode 253.

Impedance between the first electrode 252 and the second electrode 253 may be more accurately measured compared to the case where the first electrode 252 and the second electrode 253 are not alternately arranged, or the case where only one first electrode 252 and one second electrode 253 are provided.

The plurality of terminals 254 and 255 may include a first terminal 254 and a second terminal 255. The first terminal 254 may be electrically connected to the first electrode 252. The second terminal 255 may be electrically connected to the second electrode 253. For example, the first terminal 254 may be connected to the first electrode 252 through a first connection pattern 256, and the second terminal 255 may be connected to the second electrode 253 through a second connection pattern 257.

The first terminal 254 and the second terminal 255 may be spaced apart from each other. The first terminal 254 and the second terminal 255 may be disposed at a lower end of the insulator substrate 251 to be spaced apart from each other. The first terminal 254 and the second terminal 255 may be disposed to be exposed to one side of the lower wall of the cartridge 200. As the first terminal 254 and the second terminal 255 are brought into contact with the connection terminal 155 of the body 100 while the cartridge 200 is coupled to the body 100, the first terminal 254 and the second terminal 255 may be electrically connected to respective terminals included in the connection terminal 155.

Referring to FIG. 9, the first electrode 252 and the second electrode 253 may extend from a lower end surface to an upper end surface of the chamber C1.

One end of the level sensor 250 may be fixed to one side of the lower end surface of the chamber C1, and another end thereof may be fixed to one side of the upper end surface of the chamber C1. For example, one end of the insulator substrate 251 may be fixed to one side of the lower end surface of the chamber C1, and another end thereof may be fixed to one side of the upper end surface of the chamber C1.

As the plurality of electrodes 252 and 253 of the level sensor 250 extend from the lower end surface to the upper end surface of the chamber C1, the aerosol generating device 10 may accurately determine the amount of liquid aerosol generating substance, ranging from the state of being filled with a liquid aerosol generating substance in the chamber C1 to the state of having no liquid aerosol generating substance (used-up or exhausted state) in the chamber C1.

Referring to FIG. 10, the first electrode 252 and the second electrode 253 may extend from the lower end surface of the chamber C1 to a predetermined height.

For example, one end of the level sensor 250 may be fixed to one side of the lower end surface of the chamber C1, and another end thereof may be disposed inside the chamber C1. In this case, the predetermined height may be less than or equal to 1/10 of a height of the chamber C1 from its lower end surface to its upper end surface.

As the plurality of electrodes 252 and 253 of the level sensor 250 extend only to the predetermined height from the lower end surface of the chamber C1, the aerosol generating device 10 may accurately determine the state of no or a very small amount of liquid aerosol generating substance (exhausted state) in the chamber C1.

Meanwhile, the insulator substrate 251 of the level sensor 250 may be disposed such that a surface on which the first electrode 252 and the second electrode 253 are provided faces the upper end surface of the chamber C1. In this case, the insulator substrate 251, the first electrode 252, and the second electrode 253 may extend in a direction perpendicular to the longitudinal direction of the chamber C1 (the front-and-rear direction).

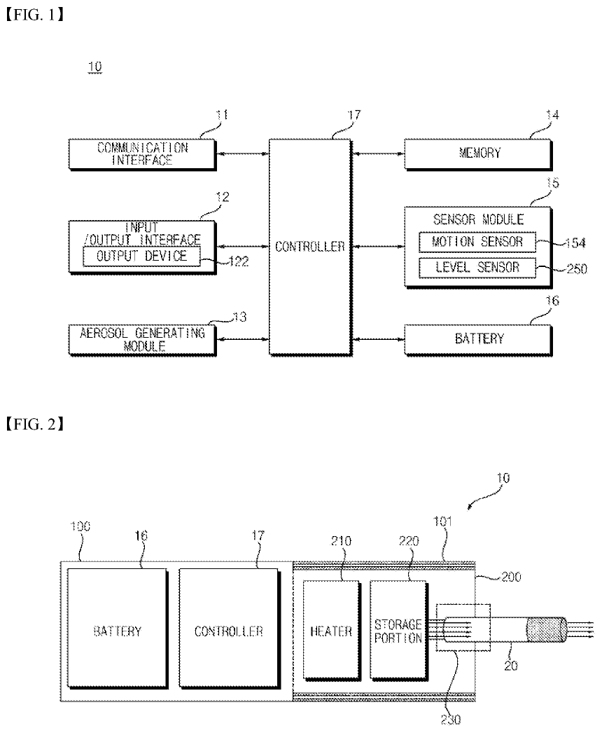

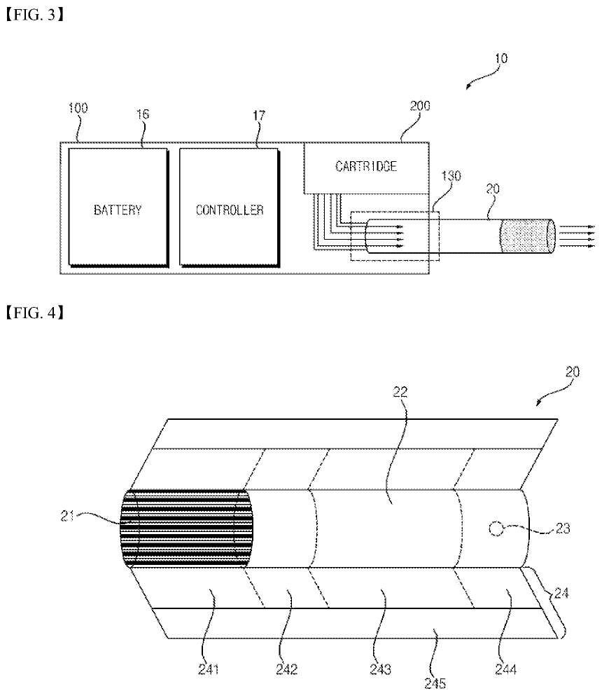

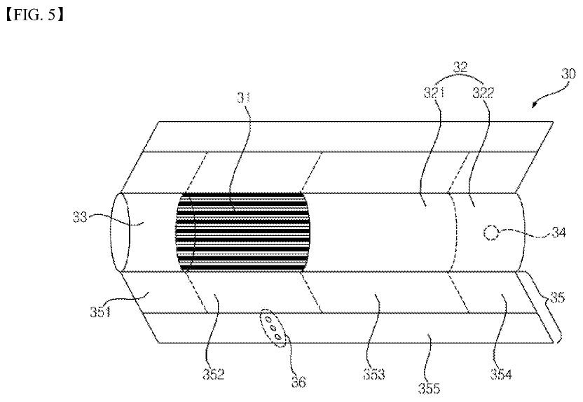

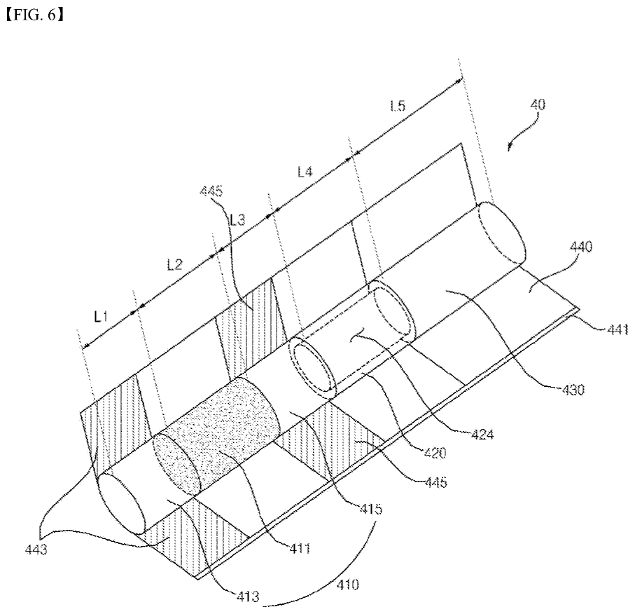

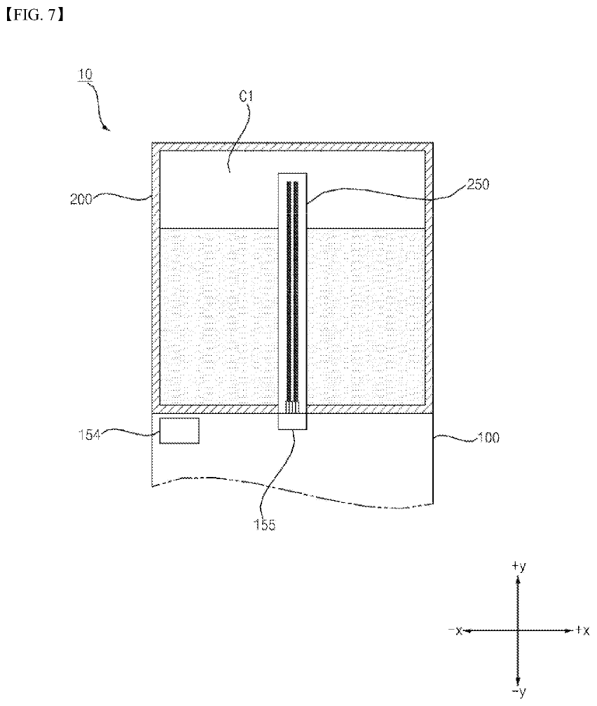

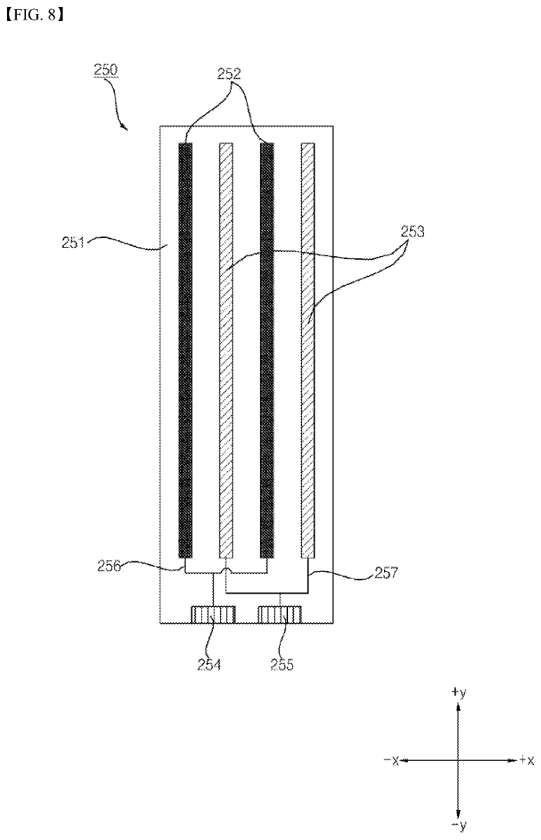

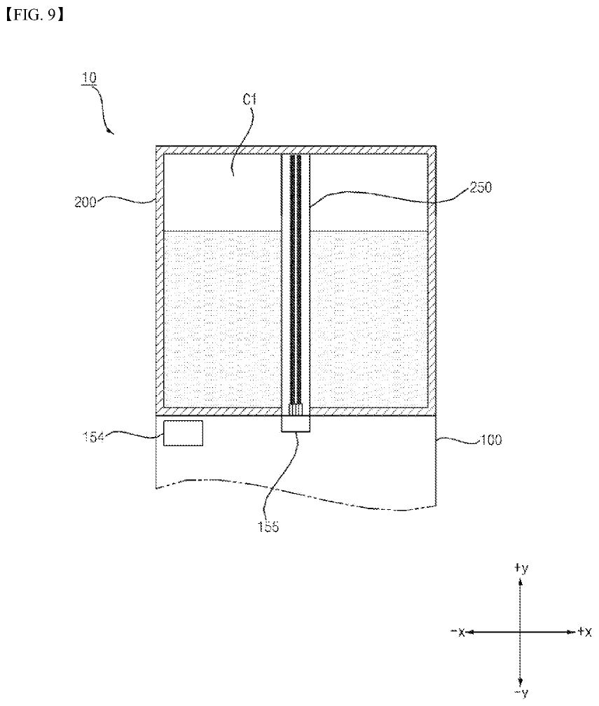

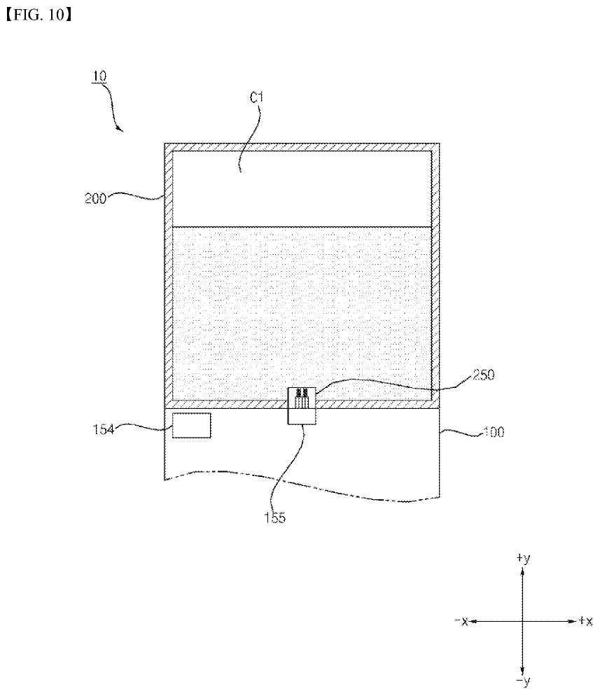

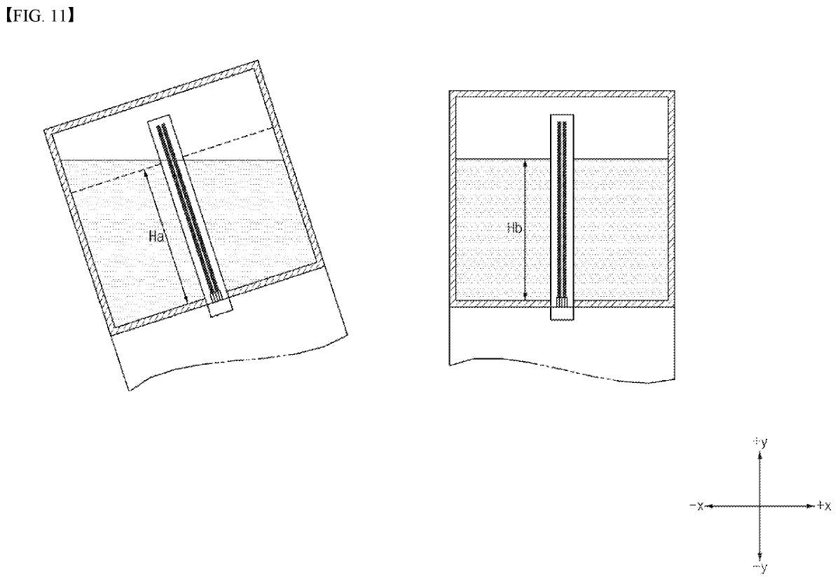

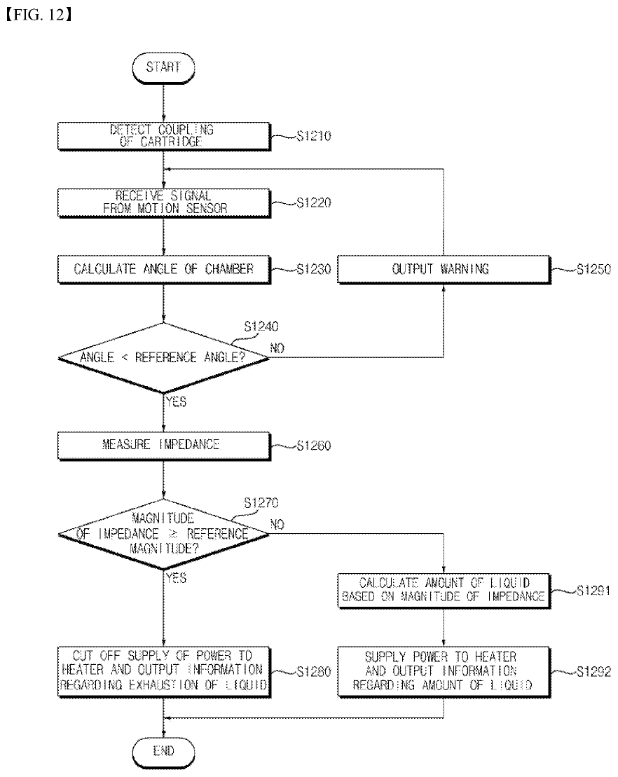

Referring to FIG. 11, the level sensor 250 may be disposed at a center of the lower end surface of the chamber C1 or adjacent to the center of the lower end surface of the chamber C1.

The insulator substrate 251 may extend from the center of the lower end surface of the chamber C1 or a position adjacent to the center of the lower end surface of the chamber C1 in the longitudinal direction of the chamber C1.

When the plurality of electrodes 252 and 253 of the level sensor 250 extend from the center of the lower end surface of the chamber C1 in the longitudinal direction, although the chamber C1 is disposed to be inclined at a predetermined degree to the ground (or horizontal level), a height Ha at which the plurality of electrodes 252 and 253 of the level sensor 250 are submerged in the liquid aerosol generating substance may be equal to or very close to a height Hb at which the plurality of electrodes 252 and 253 of the level sensor 250 are submerged in the liquid aerosol generating substance while the chamber C1 is disposed perpendicular to the ground. Thus, even when the chamber C1 is disposed to be inclined at the predetermined degree to the ground, the aerosol generating device 10 may accurately determine the amount of liquid aerosol generating substance.

The motion sensor 154 may measure motion information including a movement state, a posture, and a degree of inclination of the aerosol generating device 10, and may output a signal corresponding to the measured information. The motion sensor 154 may be implemented as at least one of a gyro sensor and an acceleration sensor. The motion sensor 154 may be disposed in at least one of the body 100 and the cartridge 200.

The controller 17 may measure impedance between the first electrode 252 and the second electrode 253 of the level sensor 250. The controller 17 may calculate the amount of liquid aerosol generating substance in the chamber C1 based on the magnitude of the measured impedance.

The battery 16 may supply power to the heater 210 under the control of the controller 17.

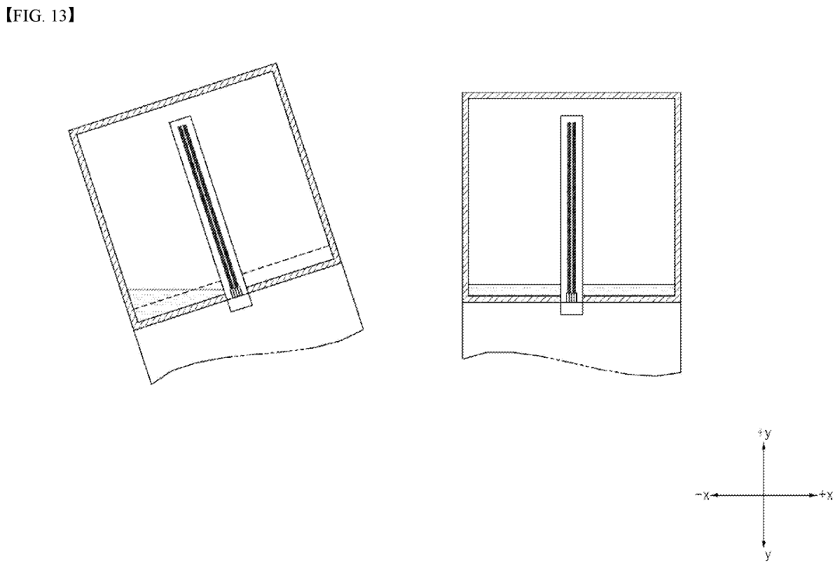

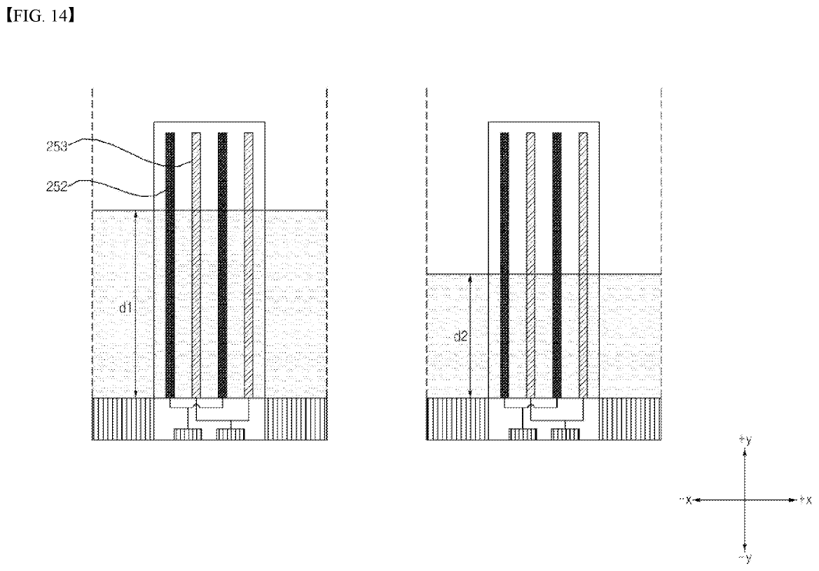

FIG. 12 is a flowchart illustrating the operation of an aerosol generating device, according to an embodiment of the present disclosure, and FIGS. 13 and 14 are views for explaining the operation of the aerosol generating device.

Referring to FIG. 12, the aerosol generating device 10 may detect coupling of the cartridge 200 in operation S1210. When an event, such as the device being turned on or receiving a user input through the input device, occurs, the aerosol generating device 10 may detect whether the cartridge 200 is coupled to the body 100.

The aerosol generating device 10 may determine whether the cartridge 200 is coupled to the body 100 through one terminal of the body 100. The aerosol generating device 10 may transmit a pulse current through one terminal connected to the cartridge 200. In this case, the aerosol generating device 10 may detect whether the cartridge 200 is coupled to the body 100 based on whether the pulse current is received through another terminal. Here, the one terminal of the body 100 may be the connection terminal 155.

The aerosol generating device 10 may receive a measurement signal from the motion sensor 154 in operation S1220.

The aerosol generating device 10 may calculate an angle of the chamber C1 in operation S1230. The angle of the chamber C1 may be defined as an angle formed by the longitudinal direction of the chamber C1 with a vertical line in a direction perpendicular to the ground. The motion sensor 154 may measure motion information including a movement state, a posture, and a degree of inclination of the aerosol generating device 10, and may output a signal corresponding to the measured information. The aerosol generating device 10 may calculate the angle of the chamber C1 based on the signal received from the motion sensor 154.

For example, when the upper end surface of the chamber C1 faces upward, the inclination of the aerosol generating device 10 may be calculated as 0 degree. For example, when the upper end surface of the chamber C1 faces leftward, the inclination of the aerosol generating device 10 may be calculated as 90 degrees.

The aerosol generating device 10 may compare the calculated angle of the chamber C1 with a reference angle in operation S1240. The aerosol generating device 10 may determine whether the calculated angle A is less than the reference angle. For example, the reference angle may be 15 degrees or 30 degrees. However, the reference angle is not limited thereto.

Based on the calculated angle being greater than or equal to the reference angle, the aerosol generating device 10 may output a warning through the output device 122 in operation S1250. For example, the aerosol generating device 10 may output, through the output device 122, information indicating that a determination for the amount and/or the presence or absence of liquid aerosol generating substance in the chamber C1 is unavailable due to the inclined chamber C1. For example, since the chamber C1 is inclined, the aerosol generating device 10 may output, through the output device 122, information that guides alignment of the device with a direction perpendicular to the ground.

After outputting the warning, the aerosol generating device 10 may receive a measurement signal from the motion sensor 154 again (operation S1220).

The amount and/or the presence or absence of liquid may not be accurately determined while the chamber C1 is inclined with respect to the ground. As shown in FIG. 13, even when a liquid aerosol generating substance is present in the chamber C1, the first electrode 252 and the second electrode 253 of the level sensor 250 may not be brought into contact with the liquid aerosol generating substance, due to the chamber C1 being inclined in one direction. In this case, the aerosol generating device 10 may incorrectly determine that the liquid aerosol generating substance in the chamber C1 is exhausted. In addition, the aerosol generating device 10 may incorrectly determine that the amount of liquid aerosol generating substance in the chamber C1 is smaller than the actual amount of the liquid aerosol generating substance in the chamber C1.

As the aerosol generating device 10 determines the amount and/or the presence or absence of liquid only when the chamber C1 is disposed at an angle less than or equal to a predetermined angle with respect to the direction perpendicular to the ground, the amount and/or the presence or absence of the liquid may be accurately determined.

Based on the calculated angle being less than the reference angle, the aerosol generating device 10 may measure impedance in operation S1260. The aerosol generating device 10 may control such that power is supplied to the level sensor 250, and may measure impedance between the first electrode 252 and the second electrode 253 of the level sensor 250. For example, the aerosol generating device 10 may apply an AC voltage between the first electrode 252 and the second electrode 253 through the first terminal 255 and the second terminal 256 to measure a current flowing through the terminal 255 and the second terminal 256. Based on the applied voltage and the measured current, the aerosol generating device 10 may calculate the impedance between the first electrode 252 and the second electrode 253. Meanwhile, the aerosol generating device 10 may apply a DC voltage between the first electrode 252 and the second electrode 253 through the first terminal 255 and the second terminal 256, and may measure a current flowing through the first terminal 255 and the second terminal 256 to calculate the impedance.

The aerosol generating device 10 may compare the magnitude of the calculated impedance with a reference magnitude in operation S1270. The aerosol generating device 10 may determine whether the magnitude of the calculated impedance is greater than or equal to the reference magnitude.

When the calculated impedance is greater than or equal to the reference magnitude, the aerosol generating device 10 may determine that the liquid aerosol generating substance in the chamber C1 is exhausted. Based on the calculated impedance being greater than or equal to the reference magnitude, the aerosol generating device 10 may output information, through the output device 122, regarding exhaustion of the liquid aerosol generating substance and/or replacement of the cartridge 200 in operation S1280.

Based on the liquid aerosol generating substance being exhausted, the aerosol generating device 10 may control such that the supply of power to heater 210 is cut off. For example, the aerosol generating device 10 may control such that the supply of power to the heater 210 is cut off until before the cartridge 200 is removed from the body 100.

When the calculated impedance is greater than or equal to the reference magnitude, the aerosol generating device 10 may determine that the liquid aerosol generating substance in the chamber C1 is not exhausted. When the calculated impedance is less than the reference magnitude, the aerosol generating device 10 may calculate the amount of the liquid aerosol generating substance in the chamber C1 based on the magnitude of the calculated impedance in operation S1291.

Referring to FIG. 14, when a voltage is applied between the first electrode 252 and the second electrode 253, a current may flow in the first electrode 252 and the second electrode 253. As the first electrode 252 and the second electrode 253 are disposed to be spaced apart from each other on the insulator substrate 251, the magnitude of impedance between the first electrode 252 and the second electrode 252 may have a very large value in a state where no liquid aerosol generating substance is present in the chamber C1. When a liquid aerosol generating substance is present in the chamber C1, portions of the first electrode 252 and the second electrode 253 are immersed in the liquid aerosol generating substance. Here, a higher current may flow in the portions of the first electrode 252 and the second electrode 253 submerged in the liquid aerosol generating substance than may in the other portions not submerged in the liquid aerosol generating substance. As the portions between the first electrode 252 and the second electrode 253 are immersed in the liquid aerosol generating substance, the magnitude of impedance between the first electrode 252 and the second electrode 253 may have a relatively small value compared to the case where no liquid aerosol generating substance is present in the chamber C1.

The magnitude of impedance between the first electrode 252 and the second electrode 253 may be reduced in proportion to the height of portions of the first electrode 252 and the second electrode 253 submerged in the liquid aerosol generating substance. The magnitude of impedance between the first electrode 252 and the second electrode 253 may have a smaller value when the height of the portions of the first electrode 252 and the second electrode 253 submerged in the liquid aerosol generating substance is high (d1 of FIG. 14) than when the height of the portions of the first electrode 252 and the second electrode 253 submerged in the liquid aerosol generating substance is low (d2 of FIG. 14).

The amount of liquid aerosol generating substance in the chamber C1 may be proportional to the height of the liquid aerosol generating substance. Accordingly, the magnitude of impedance between the first electrode 252 and the second electrode 253 may be reduced in proportion to the amount of liquid aerosol generating substance in the chamber C1.

The aerosol generating device 10 may calculate the amount of liquid aerosol generating substance in the chamber C1 based on matching information stored in the memory 14. The memory 14 may store information by matching the magnitude of impedance between the plurality of sensing electrodes 252 and 253 of the level sensor 250 and the amount of liquid aerosol substance in the cartridge 200. The aerosol generating device 10 may compare the magnitude of impedance with the matching information stored in the memory 14 to calculate information about the amount of the liquid aerosol generating substance matching the magnitude of the impedance.

Meanwhile, matching information between the magnitude of impedance and the amount of liquid aerosol generating substance may vary depending on the type of the cartridge 200. The memory 14 may store ID information according to the type of the cartridge 200. For each ID of the cartridge 200, information may be stored in the memory 14 by matching the magnitude of impedance between the plurality of sensing electrodes 252 and 253 of the level sensor 250 to the amount of liquid aerosol generating substance in the cartridge 200. When the cartridge 200 is coupled to the body 100, the aerosol generating device 10 may receive ID information of the cartridge 200 from the cartridge 200. The aerosol generating device 10 may compare matching information corresponding to the received ID information, among the matching information stored in the memory 14, with the magnitude of impedance. The aerosol generating device 10 may calculate information about the amount of the liquid aerosol generating substance matching the magnitude of the impedance.

The aerosol generating device 10 may output, through the output device 122, information regarding the amount of the liquid aerosol generating substance in operation S1292.

Based on the liquid aerosol generating substance not being exhausted, the aerosol generating device 10 may control such that power is supplied to the heater 210. For example, the aerosol generating device 10 may supply power to the heater 210 to preheat and/or heat the heater 210 until a puff is detected through the puff sensor (not shown). For example, the aerosol generating device 10 may supply power to the heater 210 based on a predetermined temperature profile.

Meanwhile, the aerosol generating device 10 may calculate an angle and movement of the chamber C1 based on a signal received from the motion sensor 154 in operation S1230, and may compare the angle of the chamber C1 with a reference angle to compare a value corresponding to the movement of the chamber C1 with reference movement in operation S1240. Based on the angle being less than or equal to the reference angle and the value corresponding to the movement being less than or equal to the reference movement, the aerosol generating device 10 may measure impedance between the first electrode 252 and the second electrode 253 of the level sensor 250 in operation S1260. Based on the magnitude of the measured impedance, the aerosol generating device 10 may calculate the amount of the liquid aerosol generating substance in the chamber C1 and/or determine the presence or absence of the liquid aerosol generating substance.

As the aerosol generating device 10 determines, in consideration of both an angle of the chamber C1 and a degree of movement of the chamber C1, the amount and/or the presence or absence of liquid aerosol generating substance only when both the angle and the degree of movement are less than or equal to a predetermined level, the amount and/or the presence or absence of the liquid aerosol generating substance may be accurately determined.

As described above, according to at least one of the embodiments of the present disclosure, the amount of aerosol generating substance in a cartridge may be accurately determined.

According to at least one of the embodiments of the present disclosure, power supplied to a heater may be adjusted or controlled when an aerosol generating substance is exhausted.

According to at least one of the embodiments of the present disclosure, exhaustion of an aerosol generating substance and the replacement time of a cartridge may be properly informed to a user.

Referring to FIGS. 1 to 14, an aerosol generating device 10 according to one aspect of the present disclosure may include: an elongated chamber C1 configured to store a liquid aerosol generating substance; and a level sensor 250 disposed inside the chamber C1. The level sensor 250 may include an insulator substrate 251 extending in a longitudinal direction of the chamber C1; and a plurality of sensing electrodes 252 and 253 each made of a conductor extending in the longitudinal direction and disposed to be laterally spaced apart from each other on the insulator substrate 251. At least a portion of the plurality of sensing electrodes 252 and 253 may be positioned to contact the liquid aerosol generating substance in the chamber C1.

According to another aspect of the present disclosure, the plurality of sensing electrodes 252 and 253 may extend from a lower end to an upper end of the chamber C1.

According to another aspect of the present disclosure, the plurality of sensing electrodes 252 and 253 may extend from a lower end of the chamber C1 to a predetermined height.

According to another aspect of the present disclosure, the level sensor 250 may be disposed at a center of a lower end of the chamber C1 or adjacent to the center of the lower end of the chamber C1. The insulator substrate 251 may extend from the center of the lower end of the chamber C1 or a position adjacent to the center of the lower end of the chamber C1 in the longitudinal direction of the chamber C1.

According to another aspect of the present disclosure, the plurality of sensing electrodes 252 and 253 may include: at least one first electrode 252 extending in the longitudinal direction; and at least one second electrode 253 extending in the longitudinal direction and disposed to be spaced apart from the at least one first electrode 252. The at least one first electrode 252 and the at least one second electrode 253 may be alternately disposed with respect to a direction intersecting the longitudinal direction.

According to another aspect of the present disclosure, the aerosol generating device 10 may further include a controller 17. The controller 17 may be configured to: measure impedance between the at least one first electrode 252 and the at least one second electrode 253; and calculate an amount of the liquid aerosol generating substance in the chamber C1 based on a magnitude of the measured impedance.

According to another aspect of the present disclosure, the controller 17 may be configured to: determine that the liquid aerosol generating substance in the chamber C1 has been exhausted based on the magnitude of the measured impedance being greater than or equal to a reference impedance value.

According to another aspect of the present disclosure, the aerosol generating device 10 may further include a heater 210; and an output device 122. The controller 17 may be configured to: output, through the output device 122, information regarding the amount of the liquid aerosol generating substance or exhaustion of the liquid aerosol generating substance; and turn off power to the heater 210 based on the liquid aerosol generating substance having been exhausted.

According to another aspect of the present disclosure, the aerosol generating device 10 may further include a motion sensor 154; and an output device 122. The controller 17 may be configured to: determine, based on a signal received from the motion sensor 154, an angle of the chamber C1 with respect to a direction perpendicular to a horizontal level; output, based on the angle being greater than or equal to a reference angle, a warning through the output device 122; and control, based on the angle being less than the reference angle, power to be supplied to the level sensor 250, and measure impedance between the at least one first electrode 252 and the at least one second electrode 253.

According to another aspect of the present disclosure, the aerosol generating device 10 may further include: a body 100 including a connection terminal 155; a cartridge 200 coupled to the body 100; and a controller 17. The cartridge 200 may include the chamber C1 and the level sensor 250. The controller 17 may be configured to: determine whether the cartridge 200 and the body 100 are coupled to each other through the connection terminal 155; and control, based on the cartridge 200 and the body 100 being coupled to each other, power to be supplied to the level sensor 250.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
an elongated chamber configured to store a liquid aerosol generating substance; and
a level sensor disposed inside the chamber,
wherein the level sensor comprises:
an insulator substrate extending in a longitudinal direction of the chamber; and
a plurality of sensing electrodes each made of a conductor extending in the longitudinal direction and disposed to be laterally spaced apart from each other on the insulator substrate,
wherein at least a portion of the plurality of sensing electrodes is positioned to contact the liquid aerosol generating substance in the chamber.

2. The aerosol generating device of claim 1, wherein the plurality of sensing electrodes extend from a lower end to an upper end of the chamber.

3. The aerosol generating device of claim 1, wherein the plurality of sensing electrodes extend from a lower end of the chamber to a predetermined height.

4. The aerosol generating device of claim 1, wherein the level sensor is disposed at a center of a lower end of the chamber or adjacent to the center of the lower end of the chamber, and
wherein the insulator substrate extends from the center of the lower end of the chamber or a position adjacent to the center of the lower end of the chamber in the longitudinal direction of the chamber.

5. The aerosol generating device of claim 1, wherein the plurality of sensing electrodes comprises:
at least one first electrode extending in the longitudinal direction; and
at least one second electrode extending in the longitudinal direction and disposed to be spaced apart from the at least one first electrode,
wherein the at least one first electrode and the at least one second electrode are alternately disposed with respect to a direction intersecting the longitudinal direction.

6. The aerosol generating device of claim 5, further comprising a controller configured to:
measure impedance between the at least one first electrode and the at least one second electrode; and
calculate an amount of the liquid aerosol generating substance in the chamber based on a magnitude of the measured impedance.

7. The aerosol generating device of claim 6, wherein the controller is further configured to:
determine that the liquid aerosol generating substance in the chamber has been exhausted based on the magnitude of the measured impedance being greater than or equal to a reference impedance value.

8. The aerosol generating device of claim 7, further comprising:
a heater; and
an output device,
wherein the controller is further configured to:
output, through the output device, information regarding the amount of the liquid aerosol generating substance or exhaustion of the liquid aerosol generating substance; and
turn off power to the heater based on the liquid aerosol generating substance having been exhausted.

9. The aerosol generating device of claim 6, further comprising:
a motion sensor; and
an output device,
wherein the controller is further configured to:
determine, based on a signal received from the motion sensor, an angle of the chamber with respect to a direction perpendicular to a horizontal level;
output, based on the angle being greater than or equal to a reference angle, a warning through the output device; and
control, based on the angle being less than the reference angle, power to be supplied to the level sensor, and measure impedance between the at least one first electrode and the at least one second electrode.

10. The aerosol generating device of claim 1, further comprising:
a body comprising a connection terminal;
a cartridge coupled to the body; and
a controller,
wherein the cartridge comprises the chamber and the level sensor, and
wherein the controller is configured to:
determine, through the connection terminal, whether the cartridge and the body are coupled to each other; and
control, based on the cartridge and the body being coupled to each other, power to be supplied to the level sensor.
